(19) United States
(12) Patent Application Publication
(10) Pub. No.: US 2021/0197482 A1
(43) Pub. Date: Jul. 1, 2021

(54) PRINTERS

(71) Applicant: HEWLETT-PACKARD DEVELOPMENT COMPANY, L.P., Spring, TX (US)

(72) Inventors: Brent EWALD, Vancouver, WA (US); Pierre J. KAISER, Vancouver, WA (US); John GEILE, Vancouver, WA (US); Mike Rode, Vancouver, WA (US)

(73) Assignee: HEWLETT-PACKARD DEVELOPMENT COMPANY, L.P., Houston, TX (US)

(21) Appl. No.: 16/075,175

(22) PCT Filed: Apr. 20, 2017
(86) PCT No.: PCT/US2017/028647

§ 371 Date: Aug. 3, 2018

(51) Int. Cl. B29C 64/393; B33Y 30/00; B33Y 50/02; B29C 64/209

(52) U.S. Cl. CPC B29C 64/393; B29C 64/209; B33Y 50/02; B33Y 30/00

(57) ABSTRACT

Printers and associated printer maintenance methods and apparatus are disclosed. A printer including a work area; a temperature sensor to measure a first temperature value at a first region of the work area and a second temperature value at a second region of the work area; and a recoater to distribute a first amount of build material onto the first region and a second amount of the build material onto the second region in response to the first temperature value being a threshold different than the second temperature value.

### BACKGROUND

Additive manufacturing systems may be used to produce three-dimensional objects. In some examples, the three-dimensional objects are produced in layers using build material.

### BRIEF DESCRIPTION OF THE DRAWINGS

FIG. 1 is a schematic illustration of an example printer in accordance with the teachings of this disclosure.

FIG. 2 is a schematic illustration of the example build material distributing controller of FIG. 1.

FIG. 3 is a flowchart representative of example machine readable instructions that may be executed to implement the example build material distributing controller of FIG. 2.

FIG. 4 is another flowchart representative of example machine readable instructions that may be executed to implement the example build material disturbing controller of FIG. 2.

FIG. 5 is a processor platform to execute the instructions of FIGS. 3 and 4 to implement the build material distributing controller of FIG. 2 according to an example.

The figures are not to scale. Wherever possible, the same reference numbers will be used throughout the drawing(s) and accompanying written description to refer to the same or like parts. While the drawings illustrate examples of printers, other examples may be employed to implement the examples disclosed herein.

### DETAILED DESCRIPTION

The examples disclosed herein relate to three-dimensional (3-D) printers that selectively deposit build material on a work area based on characteristics of the build material, parameters within the printer and/or characteristics of the object being produced or, more generally, calibrating example printers. In some examples, the build material is selectively deposited on the work area by first depositing different amounts of the build material on a staging area adjacent the work area in a side-to-side manner using a build material distributer. In such examples, the build material gradient formed on the staging area enables an associated build material gradient to be formed on the work area when a spreading carriage and/or recoater spreads the build material over a full width of the work area. In some examples, the examples disclosed herein change a build material distributing profile to increase the uniformity of the object being produced, provide enhanced production control and/or reduce over depositing build material on a work area on which an object(s) is being produced.

In some examples, when producing an object(s) using the example printers disclosed herein, thermal imbalances on the work area may cause inconsistencies in the object(s) being produced. To discourage the work area from being thermally imbalanced and/or to address thermal imbalancing identified on the work area, the examples disclosed herein monitor the temperature of the work area and selectively distribute more build material on a layer-wide basis in a hotter region(s) of the work area as compared to cooler regions of the work area. In other words, the examples disclosed herein address thermal imbalancing within a 3-D printer by differently depositing build material on the work area and/or an associated staging area prior to the build material being deposited on the work area. Distributing more build material on a layer-wide basis in regions of the work area having higher temperatures enables the temperature of the work area in those regions to be reduced by transferring heat to the build material via conduction.

In some examples, when producing different objects using the example printers disclosed herein, different build materials may be used. These different build materials may form different material gradients on the work area when distributed in the same manner based on material property differences between the build materials. To deter different build materials from being deposited with different gradients on the work area, in some examples, a build material distributing profile (e.g., a speed profile; a mass profile) is determined and/or selected for each build material that causes the first and second build materials to be deposited on the work area such that the gradient of a first material is substantially similar to the gradient of a second material. In some examples, the first material is deposited by moving a build material distributer at a first speed over a staging area adjacent a work area and the second material is deposited by moving the build material distributer at a second speed over the staging area adjacent the work area. In such examples, by moving the build material distributer at different speeds, a build material gradient may be formed on the staging area. In other words, the speed that the build material distributer moves is related to the amount of the build material dispersed. Regardless of how the first and second materials are applied to the work area and/or the associated staging area, the different build material distributing profiles enable a desired build material gradient to be achieved on the work area regardless of the build material being used.

In some examples, when producing an object(s) using the example printers disclosed herein, some regions of the work area consume more build material than other regions. For example, regions of the work area where a layer(s) of the object(s) is being formed may consume more build material than regions of the work area where no layer(s) of the object(s) is being formed. To provide the build material to regions of the work area where the layer(s) is being formed without providing too much build material to areas of the work area where the layer(s) is not being formed, the examples disclosed herein identify and distribute on a work area-width basis more build material in the region(s) of the work area where the layer(s) of the object(s) is being formed as compared to other regions of the work area and/or deposit more build material on a first side of a staging area as compared to a second side of the staging area. Distributing more build material in regions of the work area where the layer(s) of the object is being formed reduces the amount of the build material that would otherwise be over deposited in regions where no layer(s) of the object is being formed.

In some examples, when producing an object(s) using the example printers disclosed herein, a build material distributer and/or a recoater may deposit build material on the work area in an inconsistent manner (e.g., non-uniform dosing). For example, the build material distributer and/or the recoater may deposit more build material at the front of the work area as compared to the back of the work area. To deter the build material from being deposited inconsistently and/or, more generally, to calibrate the printer, in some examples, a build material distributing profile (e.g., a speed profile; a mass profile) is determined and/or selected that causes the build material to be deposited in a consistent and/or selected manner. In some examples, the build material distributing profile includes causing a recoater and/or the build material distributer to move at a first speed over a beginning portion of the work area and/or the associated staging area and causing the recoater and/or a build material distributer to move at a second speed over a back portion of the work area and/or the associated staging area. In such examples, the amount of build material deposited is inversely proportional to the speed that the build material distributer moves relative to a staging area and/or the speed that the recoater moves relative to the work area. Regardless of how the first and second materials are applied to the work area, the build material distributing profiles enable a selected build material gradient to be achieved on the work area.

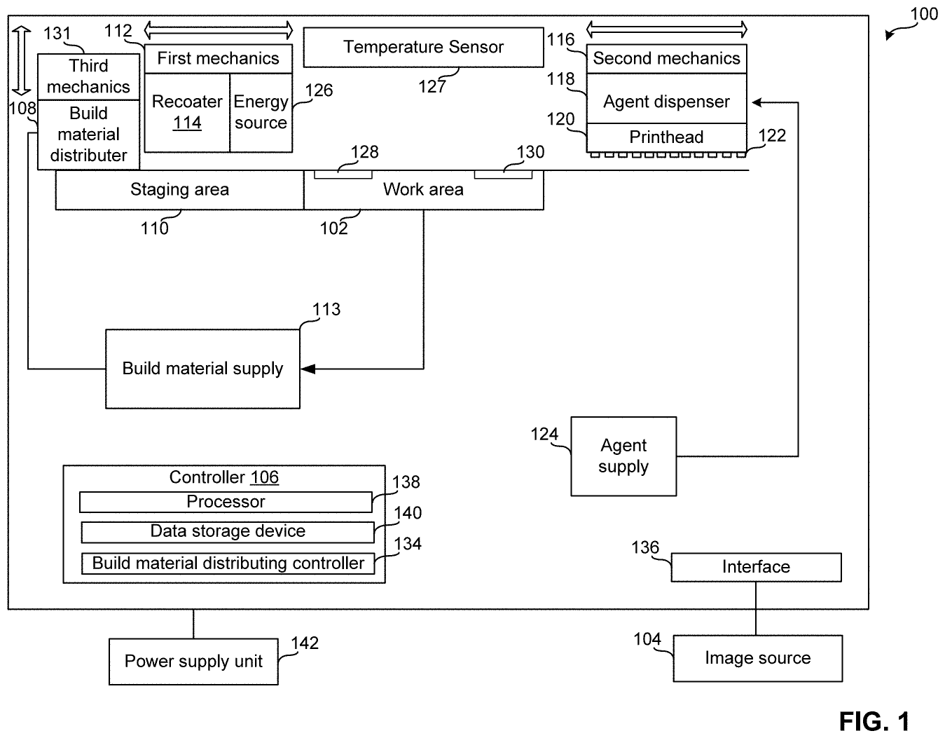

FIG. 1 is a block diagram of an example printer 100 that can be used to implement the teachings of this disclosure. The printer 100 of FIG. 1 is implemented as a 3-D printer that may be used to generate objects, parts, etc. To generate an object on an example work area (e.g., a bed) 102, in the illustrated example, the printer 100 includes an image source 104 from which the printer 100 receives an image(s) and/or other data (e.g., a file) describing the object(s) to be produced on the work area 102.

To produce the object(s) on the work area 102 based on the image(s) and/or other data describing the object, an example controller 106 causes an example build material distributer 108 to distribute build material on a staging area 110. In some examples, the staging area 110 is implemented as a movable belt on which the build material is deposited from the build material distributer 108. In some examples, the speed of the belt is adjustable to change the amount of build material deposited from the build material distributer 108 onto the staging area 110 and/or to impart a build material gradient on the staging area 110. Additionally, in the illustrated example, to produce the object(s) on the work area 102, the controller 106 causes example first mechanics 112 to move an example recoater 114 relative to the work area 102 to dispense, spread and/or distribute a layer(s) of build material on the work area 102. In some examples, the recoater 114 includes a wiper, a roller, etc. to dispense, spread and/or distribute the build material on the work area 102. In the illustrated example, the build material is accessed from an example build material supply 113. In some examples, the work area 102 is coupled to the build material supply 113 to enable unused and/or excess build material to be returned to the build material supply 113. In some examples, some processes are performed on the build material prior to returning the build material to the build material supply 113. While the example of FIG. 1 illustrates the build material distributer 108 distributing the build material on the staging area 110 and the recoater 114 distributing, spreading and/or distributing the build material on the work area 102, in other examples, the build material distributer 108 and the recoater 114 may be combined such that the build material is directly deposited on the work area 102. In such examples, the staging area 110 may be removed and/or combined with the work area 102.

To enable the build material to be selectively fused and/or coupled to form the object(s), the controller 106 causes example second mechanics 116 to move an example agent distributer 118 including an associated example printhead 120 and nozzles 122 relative to the work area 102 and overtop of the layer of build material. In some examples, the nozzles 122 selectively deposit agent on the build material as the nozzles 122 are moved by the second mechanics 116. In the illustrated example, the agent distributer 118 and/or the printhead 120 draws and/or accesses the agent from an example agent supply 124. The agent supply 124 may include a chamber(s) (e.g., 1, 2, 3, etc.) that houses an agent(s) (e.g., 1, 2, 3, 4 types of agents) and/or another liquid(s) used during the additive manufacturing process. In some examples, the agent includes a fusing agent, a detailing agent, an agent(s) associated with accuracy and/or detail, an agent(s) associated with opacity and/or translucency and/or an agent(s) associated with surface roughness, texture and/or friction. Additionally or alternatively, in some examples, the agent includes an agent(s) associated with strength, elasticity and/or other material properties, an agent(s) associated with color (e.g., surface and/or embedded) and/or an agent(s) associated with electrical and/or thermal conductivity.

In the illustrated example, to selectively fuse and/or solidify the build material where the agent has been applied to the build material, the controller 106 causes the first mechanics 112 to move an example energy source 126 relative to the work area 102 and apply energy to the build material on the work area 102. The energy source 126 may apply any type of energy to selectively cause the build material to fuse and/or solidify. For example, the energy source 126 may include an infra-red (IR) light source, a near infra-red light source, a laser, etc. While the energy source 126 is illustrated in FIG. 1 as being positioned adjacent the build material distributer 108 and moved by the first mechanics 112, in other examples, the energy source 126 may be positioned adjacent the agent distributer 118 and moved by the second mechanics 116. In other examples, the energy source 126 may be moved by dedicated mechanics and/or stationarily disposed relative to the work area 102.

During the process of forming the object(s) on the work area 102, a temperature sensor 127 monitors the temperature(s) of different regions of the work area 102 and the controller 106 determines if the work area 102 is thermally imbalanced. In some examples, the work area 102 is considered thermally imbalanced if a portion and/or region of the work area 102 is a threshold greater temperature than another portion and/or region of the work area 102. In some examples, the temperature sensor 127 is implemented as an infrared (IR) camera that determines the temperature and/or temperature gradients of the work area 102 and/or different regions of the work area. In some examples, the temperature sensor 127 includes more than one temperature sensor where one of the temperature sensors monitors the temperature of a first region and/or side 128 of the work area 102 and a second one of the temperature sensors monitors the temperature of a second region and/or side 130 of the work area 102. In some examples, the first region 128 is adjacent a right side of the work area 102 and the second region 130 is adjacent a left side of the work area 102. However, the first and/or second regions 128, 130 may be in any location on the work area 102. Regardless of how the temperature sensor 127 is implemented, the temperature sensor 127 monitors the temperature of the work area 102 to identify temperature differences and/or temperature gradients.

In some examples, based on the monitoring, the controller 106 determines that the work area 102 is thermally imbalanced if the first side 128 of the work area 102 has a first temperature and the second side 130 of the work area 102 has a second temperature that is a threshold greater than the first temperature. To enable the temperatures of the first and second sides 128, 130 to be within a threshold of one another, in the illustrated example, the controller 106 includes an example build material distributing controller 134 that causes the build material distributer 108 and/or the recoater 114 to selectively distribute more build material on the second side 130 of the work area 102 as compared to the first side 128 of the work area 102 to encourage the heat at the second side 130 to be transferred to the additional build material via conduction. In some examples, the recoater 114 is at least as wide as a width of the work area 102. In some examples, the additional build material is deposited on the second side 130 by initially moving the build material distributer 108, via third mechanics 131, at a first speed over the staging area 110 adjacent the first side 128 and moving the build material distributer 108 at a second speed over the staging area 110 adjacent the second side 130 where the first speed is faster than the second speed. Then, in such examples, the recoater 114 spreads the build material from the staging area 110 onto the work area 102 forming a gradient including more of the build material on the second side 130 and less of the build material on the first side 128. However, the build material distributer 108 and/or the recoater 114 may selectively distribute the build material on the work area 102 in any other way.

Further, during the process of forming the object(s) on the work area 102, different build materials may be used to produce different material characteristics and/or to enable different objects to be produced including different materials. In some examples, different materials such as first and second build materials may form different gradients on the work area 102 when distributed in a substantially similar manner. As used herein, distributing the first and second build materials in a substantially similar manner means that the first and second materials are not deposited in a manner to purposefully achieve different build material gradients.

To enable a similar gradient to be achieved on the work area 102 when depositing the first and second build materials, in the illustrated example the example build material distributing controller 134 selects a build material distributing profile that causes the build material distributer 108 and/or the recoater 114 to selectively distribute the different build materials in different manners to achieve a selected and/or desired build material gradient on the staging area 110 and/or the work area 102. For example, the build material distributing controller 134 may cause the build material distributer 108 to move at a first speed when depositing the first material on the staging area 110 adjacent the work area 102 and cause the build material distributer 108 to move at a second speed when depositing the second material on the staging area 110 adjacent the work area 102. While this example describes the build material distributer 108 moving at a first speed when depositing the first material and moving at a second speed when depositing the second material, the recoater 114 and/or the build material distributer 108 may move at different speeds when depositing either of the first material or the second material to achieve the selected and/or desired build material gradient on the work area 102.

Further, during the process of forming the object(s) on the work area 102, the first side 128 of the work area 102 may consume less of the build material as compared to the second side 130 of the work area 102. For example, if an object(s) being formed includes a base that is present on the second side 130 but is not present in the first side 128, the second side 130 of the work area 102 will consume more of the build material as compared to the first side 128 of the work area 102.

To enable the build materials to be distributed differently on the staging area 110 and/or the work area 102 based on a characteristic(s) of the object(s) being formed, in the illustrated example, the example build material distributing controller 134 selects a build material distributing profile that causes the build material distributer 108 and/or the recoater 114 to selectively distribute the build materials in different manners to achieve a selected and/or desired build material gradient on the staging area 110 and/or the work area 102. For example, when the first side 128 consumes less build material than the second side 130, the build material distributing controller 134 may cause the build material distributer 108 to move at a first speed when depositing the build material on the staging area 110 adjacent the first side 128 of the work area 102 and cause the build material distributer 108 to move at a second speed when depositing the build material on the staging area 110 adjacent the second side 130 of the work area 102. In some such examples, the first speed is greater than the second speed to enable more of the build material (e.g., a greater build material buildup; a greater mass density of the build material) to be deposited on the second side 130 as compared to the first side 128.

Further, during the process of forming the object(s) on the work area 102, the build material distributer 108 and/or the recoater 114 may non-uniformly deposit the build material on the staging area 110 and/or the work area 102 based on structural properties of the printer 100. For example, the recoater 114 may tend to deposit more of the build material on the first side 128 of the work area 102 as compared to the second side 130 of the work area 102.

To enable the build material to be distributed similarly on the staging area 110 and/or the work area 102 and, more generally, to calibrate the printer 100, in the illustrated example, the example build material distributing controller 134 selects a build material distributing profile that causes the build material distributer 108 and/or the recoater 114 to selectively distribute the build materials in different manners to achieve a selected and/or desired build material gradient on the staging area 110 and/or the work area 102. For example, the build material distributing controller 134 may cause the build material distributer 108 to move at a first speed when depositing the build material over the staging area 110 adjacent the first side 128 and cause the build material distributer 108 to move at a second speed when depositing the build material over the staging area 110 adjacent the second side 130. In some such examples, the first speed is greater than the second speed to compensate for the build material being otherwise non-uniformly deposited over the work area 102.

The example printer 100 of FIG. 1 includes an interface 136 to interface with the image source 104. The interface 136 may be a wired or wireless connection connecting the printer 100 and the image source 104. The image source 104 may be a computing device from which the printer 100 receives data describing a task (e.g., an object to form, a print job, etc.) to be executed by the controller 106. In some examples, the interface 136 facilitates the printer 100 and/or a processor 138 to interface with various hardware elements, such as the image source 104 and/or hardware elements that are external and/or internal to the printer 100. In some examples, the interface 136 interfaces with an input or output device, such as, for example, a display device, a mouse, a keyboard, etc. The interface 136 may also provide access to other external devices such as an external storage device, network devices, such as, for example, servers, switches, routers, client devices, other types of computing devices and/or combinations thereof.

The example controller 106 includes the example processor 138, including hardware architecture, to retrieve and execute executable code from an example data storage device 140. The executable code may, when executed by the example processor 138, cause the processor 138 to implement at least the functionality of controlling the first mechanics 112 and/or the recoater 114 to distribute build material on the work area 102, the third mechanics 131 and/or the build material distributer 108 to distribute the build material on the staging area 110, the second mechanics 116 to move the agent distributer 118, the printhead 120 and the nozzles 122 relative to the work area 102 and/or the first mechanics 112 and/or the energy source 126 to apply energy to the build material on the work area 102 to form the object(s). The executable code may, when executed by the example processor 138, cause the processor 138 to provide instructions to an example power supply unit 142, to cause the power supply unit 142 to provide power to the example printhead 120 to eject a liquid from the example nozzle(s) 122.

The data storage device 140 of FIG. 1 stores instructions that are executed by the example processor 138 or other processing devices. The example data storage device 140 may store computer code representing a number of applications, firmware, machine readable instructions, etc. that the example processor 138 executes to implement the examples disclosed herein.

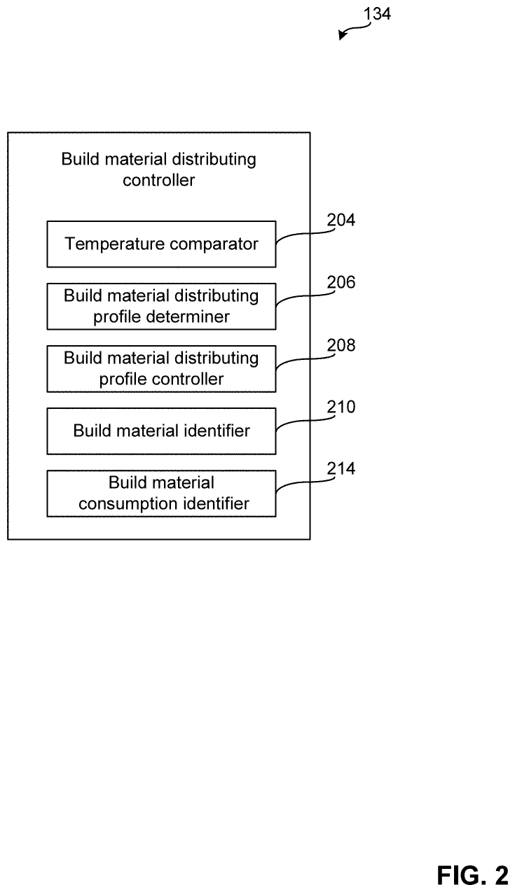

FIG. 2 illustrates an example implementation of the build material distributing controller 134 of FIG. 1. As shown in the example of FIG. 2, the build material distributing controller 134 includes an example temperature comparator 204, an example build material distributing profile determiner 206, an example build material distributing profile controller 208, an example build material identifier 210 and an example build material consumption identifier 214.

In the illustrated example, to calibrate the printer 100 to compensate for build material distributing differences and/or inconsistencies on the work area 102 and/or the staging area 110, the build material distributing profile determiner 206 determines a build material distributing profile that causes the build material distributer 108 and/or the recoater 114 to provide a commanded and/or selected build material gradient on the staging area 110 and/or the work area 102. For example, if the build material distributing profile determiner 206 determines that the recoater 114 and/or the build material distributer 108 inadvertently distributes more of the build material on the first side 128 of the work area 102 as compared to the second side 130 of the work area 102, the build material distributing profile determiner 206 may determine a build material distributing profile that, when executed by the build material profile controller 208, causes the build material distributer 108 to move at a first speed and/or distributing rate over the staging area 110 adjacent the first side 128 and to move at a second speed and/or distributing rate over the staging area adjacent the second side 130. While the above example mentions moving the build material distributer 108 at different speeds to achieve a commanded gradient of build material on the work area 102, any other method may be employed to selectively dispense, spread and/or distribute the build material on the work area 102.

In the illustrated example, to determine if the work area 102 is thermally imbalanced, the temperature comparator 204 accesses temperature values from the temperature sensor 127 and compares a first temperature value from the first side 128 and a second temperature value from the second side 130 or, more generally, compares temperature values from different regions of the work area 102. Based on the comparison, the temperature comparator 204 determines if the first temperature value or the second temperature value is a threshold greater than the other of the first temperature value or the second temperature value.

In examples in which the temperature of the first side 128 is a threshold greater than the temperature of the second side 130, the build material distributing profile determiner 206 determines and/or selects a build material distributing profile that, when executed by the build material distributing controller 208, causes more of the build material to be distributed on the first side 128 as compared to the second side 130. In other words, the build material distributing profile causes the build material distributer 108 and/or the recoater 114 to distribute the build material on the work area 102 in a non-uniform manner where the additional build material distributed on the first side 128 encourages additional heat to be absorbed and/or transferred from the first side 128 to the build material distributed thereon. More generally, distributing additional build material on the first side 128 as compared to the second side 130 reduces a temperature difference (e.g., a temperature delta) between the first side 128 and the second side 130.

In the illustrated example, to compensate for build material distribution differences such as, for example, a first build material distributing onto the work area 102 at a faster rate than a second build material, the build material identifier 210 identifies the build material being distributed and the build material distributing profile determiner 206 determines and/or identifies an associated build material distributing profile. In some examples, when the associated build material distributing profile is executed by the build material distributing controller 208, the build material distributing controller 208 causes the build material distributer 108 and/or the recoater 114 to distribute a similar build material gradient on the staging area 110 and/or the work area 102 regardless whether the first build material or the second material is being distributed.

In the illustrated example, to compensate for consumption differences on different regions of the work area 102, the build material consumption identifier 214 identifies the location(s) of the work area 102 where a layer(s) of the object(s) is to be formed and the location(s) of the work area 102 where the layer(s) of the object(s) is not be formed. As used herein, consumption of build material means that the build material is being used to form an object(s) within the 3-D printer or otherwise used in an additive manufacturing process. In response to determining the location of the layer being formed, the build material distributing profile determiner 206 determines and/or identifies an associated build material distributing profile and/or an example build material consumption profile. In some examples, when the associated build material distributing profile is executed by the build material distributing controller 208, the build material distributing controller 208 causes the build material distributer 108 and/or the recoater 114 to distribute more build material where the layer(s) of the object(s) is being formed on the work area 102 and less build material where the layer(s) of the object(s) is not being formed on the work area 102.

While an example manner of implementing the build material distributing controller 134 of FIG. 1 is illustrated in FIG. 2, the element(s), process(es) and/or device(s) illustrated in FIG. 2 may be combined, divided, re-arranged, omitted, eliminated and/or implemented in any other way. Further, the temperature comparator 204, the build material distributing profile determiner 206, the build material distributing profile controller 208, the build material identifier 210 and the build material consumption identifier 214 and/or, more generally, the example build material distributing controller 134 of FIG. 1 may be implemented by hardware, software, firmware and/or any combination of hardware, software and/or firmware. Thus, for example, any of the temperature comparator 204, the build material distributing profile determiner 206, the build material distributing profile controller 208, the build material identifier 210 and the build material consumption identifier 214 and/or, more generally, the example build material distributing controller 134 of FIG. 1 could be implemented by an analog or digital circuit(s), logic circuit(s), programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the temperature comparator 204, the build material distributing profile determiner 206, the build material distributing profile controller 208, the build material identifier 210 and the build material consumption identifier 214 and/or, more generally, the example build material distributing controller 134 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example build material distributing controller 134 of FIG. 1 may include an element(s), process(es) and/or device(s) in addition to, or instead of, those illustrated in FIG. 2, and/or may include more than one of any or all of the illustrated elements, processes and devices.

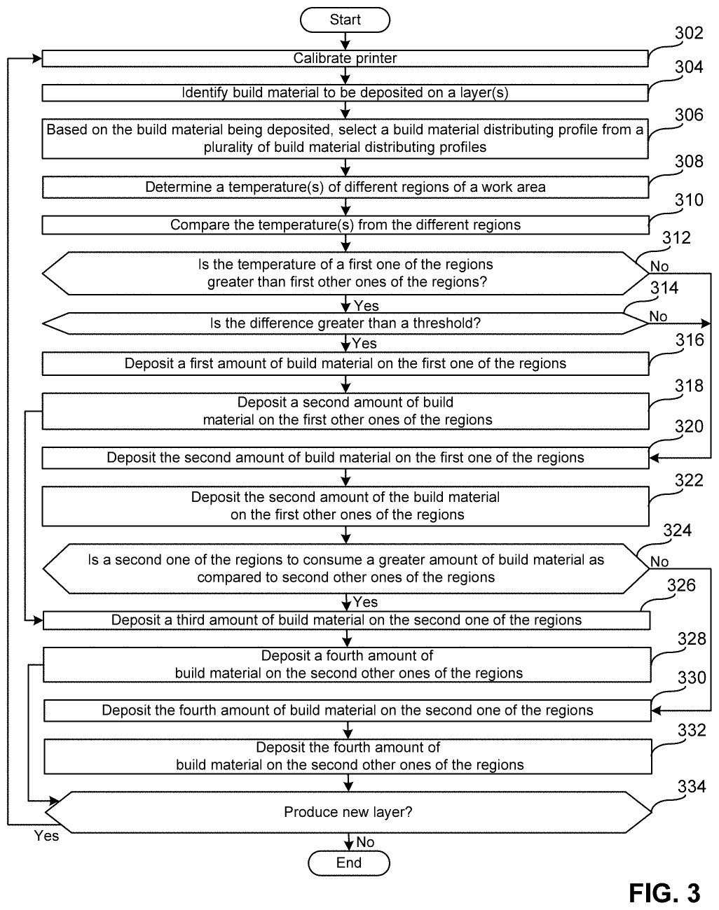

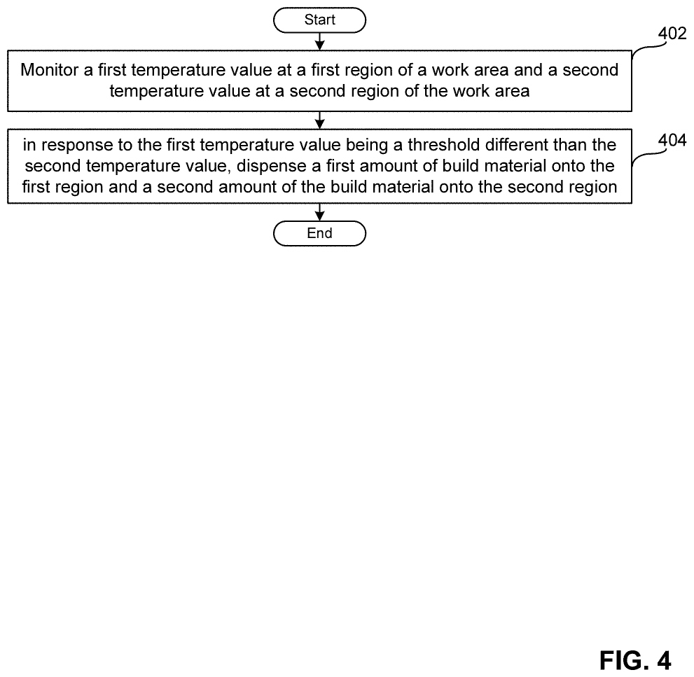

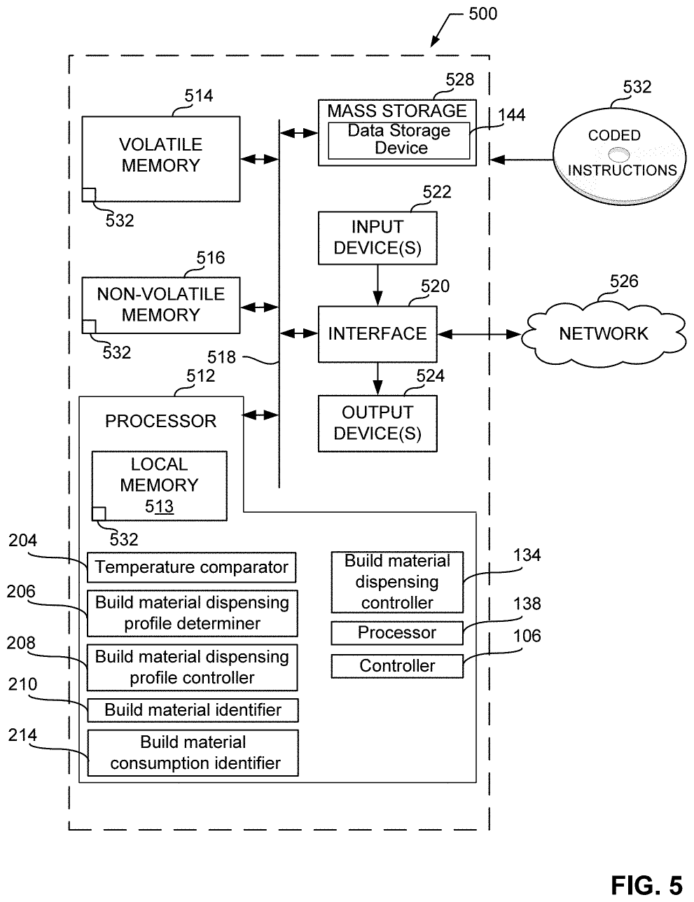

A flowchart representative of example machine readable instructions for implementing the build material distributing controller 134 of FIG. 1 is shown in FIGS. 3 and 4. In this example, the machine readable instructions comprise a program for execution by a processor such as the processor 512 shown in the example processor platform 500 discussed below in connection with FIG. 5. The program may be embodied in software stored on a tangible computer readable storage medium such as a CD-ROM, a floppy disk, a hard drive, a digital versatile disk (DVD), a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowchart illustrated in FIGS. 3 and 4, many other methods of implementing the example build material distributing controller 134 may alternatively be used. For example, the order of execution of the blocks may be changed, and/or some of the blocks described may be changed, eliminated, or combined.

As mentioned above, the example processes of FIGS. 3 and 4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 3 and 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program of FIG. 3 begins at block 302 with the printer 100 being calibrated to compensate for build material distributing inconsistencies and/or variations (block 302). In some examples, the printer 100 is calibrated by the build material distributing profile determiner 206 determining and/or selecting a build material distributing profile that enables the build material to be distributed in an expected and/or desired manner. To compensate for different build materials distributing onto the staging area 110 and/or the work area 102 at different rates, the build material identifier 210 identifies the build material being distributed (block 304) and the build material distributing profile determiner 206 determines and/or identifies an associated build material distributing profile to enable the build material to be distributed in an expected and/or desired manner (block 306).

To determine if the work area 102 is thermally imbalanced, the temperature comparator 204 accesses temperature values from different regions of the work area 102 such as the first side 128 and the second side 130 (block 308) and compares the temperatures from the different regions (block 310). Based on the comparison, the temperature comparator 204 determines if a temperature value of one of the regions of the work area 102 is greater than the other regions of the work area 102 (block 312). If the temperature value of one of the regions of the work area 102 is greater than the other regions of the work area 102, the temperature comparator 204 determines if the difference is greater than a threshold (block 314). For example, if the temperature comparator 204 determines that the temperature value of the first side 128 is a threshold greater than the temperature value of the second side 130, the build material distributing profile determiner 206 determines and/or selects a first build material distributing profile that, when executed by the build material distributing controller 208, causes a first amount of the build material to be distributed on the first side 128 (block 316) and causes a second amount of the build material to be distributed on the second side 130 (block 318). In examples in which the temperature value of the first side 128 and the temperature value of the second side 130 and/or other regions of the work area 102 are within a threshold of one another, the build material distributing profile determiner 206 determines and/or selects a second build material distributing profile that, when executed by the build material distributing controller 208, causes the second amount of the build material to be distributed on the first side 128 (block 320) and causes the second amount of the build material to be distributed on the second side 130 (block 322). In other words, when the temperature of the different regions of the work area 102 are within a threshold of one another, the selected build material distributing profile does not distribute the build material in a manner to encourage the temperature of one region of the work area 102 to reduced relative to another region of the work area 102.

To compensate for build material consumption differences on different regions of the work area 102, the build material consumption identifier 214 determines if one of the regions of the work area 102 is to consume a greater amount of the build material as compared to another one of the regions of the work area 102 (block 324). For example, if the build material consumption identifier 214 determines that the first side 128 is to consume more build material as compared to the second side 130, the build material distributing profile determiner 206 determines and/or selects a third build material distributing profile that, when executed by the build material distributing controller 208, causes a third amount of the build material to be distributed on the first side 128 (block 326) and causes a fourth amount of the build material to be distributed on the second side 130 (block 328).

In examples in which the consumption of build material between the different regions of the work area 102 are similar and/or within a threshold of one another, the build material distributing profile determiner 206 determines and/or selects a fourth build material distributing profile that, when executed by the build material distributing controller 208, causes the fourth amount of the build material to be distributed on the first side 128 (block 330) and causes the fourth amount of the build material to be distributed on the second side 130 (block 332). In other words, in some examples, when the consumption of the build material of the different regions of the work area 102 are within a threshold of one another, the selected build material distributing profile does not distribute the build material in an inconsistent and/or varied manner. At block 334, the controller 106 determines whether or not to produce another layer (block 334).

The program of FIG. 4 begins at block 402 with the temperature comparator 204 monitoring a first temperature value at the first side 128 of the work area 102 and a second temperature value at the second side 130 of the work area 102 (block 402). In response to the first temperature value being a threshold different than the second temperature value, the build material distributing profile determiner 206 determines and/or selects a build material distributing profile that, when executed by the build material distributing controller 208, causes a first amount of the build material to be distributed on the first side 128 and causes a second amount of the build material to be distributed on the second region (block 404). In examples in which the first temperature value is a threshold greater than the second temperature value, the first amount is greater than the second amount. In examples in which the second temperature value is a threshold greater than the first temperature value, the second amount is greater than the first amount. In examples in which the first temperature value and the second temperature value are within a threshold of one another, the first amount is substantially the same as the second amount. As set forth herein, the first amount being substantially the same as the second amount means that there is no purposeful difference in the amount of build material distributed on the first side 128 relative to the second side 130.

FIG. 5 is a block diagram of an example processor platform 500 capable of executing the instructions of FIGS. 3 and 4 to implement the build material distributing controller 134 of FIG. 1. The processor platform 500 can be, for example, a server, a personal computer, a mobile device (e.g., a cell phone, a smart phone, a tablet such as an iPad™), a personal digital assistant (PDA), an Internet appliance or any other type of computing device.

The processor platform 500 of the illustrated example includes a processor 512. The processor 512 of the illustrated example is hardware. For example, the processor 512 can be implemented by integrated circuits, logic circuits, microprocessors and/or controllers from any desired family or manufacturer. In the illustrated example, the processor 512 implements the example build material distributing controller 134, the example temperature comparator 204, the example build material distributing profile determiner 206, the example build material distributing profile controller 208, the example build material identifier 210, the example build material consumption identifier 214, the example build material distributing controller 134, the example processor 138 and the example controller 106.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, an input device(s) 522 is connected to the interface circuit 520. The input device(s) 522 permit(s) a user to enter data and commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

An output device(s) 524 is also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 520 of the illustrated example, thus, typically includes a graphics driver card, a graphics driver chip or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes a mass storage device(s) 528 for storing software and/or data. Examples of such mass storage devices 528 include floppy disk drives, hard drive disks, compact disk drives, Blu-ray disk drives, RAID systems, and digital versatile disk (DVD) drives. In the illustrated example, the mass storage device(s) 528 implements the data storage device 144.

The coded instructions 532 of FIGS. 3 and 4 may be stored in the mass storage device 528, in the volatile memory 514, in the non-volatile memory 516, and/or on a removable tangible computer readable storage medium such as a CD or DVD.

From the foregoing, it will be appreciated that the above disclosed methods, apparatus and articles of manufacture relate to variably and/or differently distributing build material within a 3-D printer to accommodate for thermal imbalance and/or other characteristics within the printer and/or the build material being distributed. In some examples, the build material is variably distributed by flowing the build material though a choked flow area and/or opening of a carriage while moving the carriage at different rates/speeds and/or heights relative to a staging area and/or a work area of the 3-D printer. By varying the rates/speeds and/or heights of the carriage relative to a staging area and/or work area a selected, commanded and/or desired build material gradient may be achieved within the 3-D printer such as, for example, on a staging area and/or a work area of the 3-D printer.

An example printer including a work area; a temperature sensor to measure a first temperature value at a first region of the work area and a second temperature value at a second region of the work area; and a recoater to distribute a first amount of build material onto the first region and a second amount of the build material onto the second region in response to the first temperature value being a threshold different than the second temperature value. In some examples, the printer includes a controller to determine a build material distributing profile associated with the first temperature value being the threshold different than the second temperature value, the build material distributing profile to cause the recoater, when executed by the controller, to distribute the first amount of the build material onto the first region and the second amount of the build material onto the second region. In some example, the printer includes an agent distributer including a nozzle, the agent distributer to cause the nozzle to distribute an agent onto the build material on the work area of the printer during an additive manufacturing procedure.

In some examples, the printer includes a build material distributer to distribute the build material onto a staging area to enable the recoater to distribute the first amount of the build material onto the first region and the second amount of the build material onto the second region. In some examples, the printer includes a controller to determine a build material distributing profile based on the first region of the work area consuming a third amount of the build material and the second region of the work area consuming a fourth amount of the build material. In some examples, the build material distributing profile is to cause the recoater, when executed by the controller, to distribute a fifth amount of the build material onto the first region and a sixth amount of the build material onto the second region.

In some examples, the printer includes a controller to determine a build material distributing profile for the work area based on an identity of the build material being distributed. In some examples, the build material distributing profile is to cause the recoater, when executed by the controller, to distribute a third amount of the build material onto the first region and a fourth amount of the build material onto the second region. In some examples, the printer includes a controller to calibrate the printer to enable the recoater to distribute a selected gradient of the build material onto the work area. In some examples, the printer includes an energy source to apply energy to the build material.

An example method includes monitoring a first temperature value at a first region of a work area of a printer and a second temperature value at a second region of the work area; and in response to the first temperature value being a threshold different than the second temperature value, distributing a first amount of build material onto the first region and a second amount of the build material onto the second region. In some examples, the method includes determining a build material distributing profile associated with the first temperature value being the threshold different than the second temperature value, the build material distributing profile to cause the first amount of the build material to be distributed onto the first region and the second amount of the build material to be distributed onto the second region. In some examples, the method includes distributing an agent onto the build material on the work area of the printer during an additive manufacturing procedure. In some examples, the method includes distributing the build material onto a staging area to enable the first amount of the build material to be distributed onto the first region and the second amount of the build material to be distributed onto the second region.

In some examples, the method includes determining a build material distributing profile for the work area based on the first region of the work area consuming a first amount of the build material and the second region of the work area consuming a second amount of the build material. In some examples, the method includes distributing a third amount of build material onto the first region and a fourth amount of the build material onto the second region based on the build material distributing profile. In some examples, the method includes determining a build material distributing profile for the work area based on an identity of the build material being distributed. In some examples, the method includes distributing a third amount of the build material onto the first region and a fourth amount of the build material onto the second region based on the build material distributing profile. In some examples, the method includes calibrating the printer to enable a selected gradient of the build material to be distributed on the work area.

An example apparatus includes a temperature comparator to compare a first temperature value at a first region of a work area and a second temperature value at a second region of the work area; and a build material distributing profile determiner to determine a build material distributing profile associated with distributing different amounts of build material on the first and second regions based on a difference between the first temperature and the second temperature.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A printer, comprising:
a work area;
a temperature sensor to measure a first temperature value at a first region of the work area and a second temperature value at a second region of the work area; and
a recoater to distribute a first amount of build material onto the first region and a second amount of the build material onto the second region in response to the first temperature value being a threshold different than the second temperature value.

2. The printer of claim 1, further including a build material distributer and a controller, the build material distributer to distribute the build material on a staging area adjacent the work area, the controller to determine a build material distributing profile associated with the first temperature value being the threshold different than the second temperature value, the build material distributing profile to cause the build material distributer, when executed by the controller, to distribute an associated first amount of the build material onto the staging area adjacent the first region and an associated second amount of the build material onto the staging area adjacent the second region, the recoater to distribute the build material from the staging area onto the work area.

3. The printer of claim 1, further including an agent distributer including a nozzle, the agent distributer to cause the nozzle to distribute an agent onto the build material on the work area of the printer during an additive manufacturing procedure.

4. The printer of claim 1, further including a build material distributer to distribute the build material onto a staging area to enable the recoater to distribute the first amount of the build material onto the first region and the second amount of the build material onto the second region.

5. The printer of claim 1, further including a controller to determine a build material distributing profile based on the first region of the work area consuming a third amount of the build material and the second region of the work area consuming a fourth amount of the build material.

6. The printer of claim 5, further including a build material distributer to distribute the build material on a staging area adjacent the work area, wherein the build material distributing profile is to cause the build material distributer, when executed by the controller, to distribute an associated fifth amount of the build material onto the staging area adjacent the first region and an associated sixth amount of the build material onto the staging area adjacent the second region, the recoater to distribute the build material from the staging area onto the work area.

7. The printer of claim 1, further including a controller to determine a build material distributing profile for the work area based on an identity of the build material being distributed.

8. The printer of claim 7, further including a build material distributer to distribute the build material on a staging area adjacent the work area, wherein the build material distributing profile is to cause the build material distributer, when executed by the controller, to distribute an associated third amount of the build material onto the staging area adjacent the first region and an associated fourth amount of the build material onto the staging area adjacent the second region, the recoater to distribute the build material from the staging area onto the work area.

9. The printer of claim 1, further including a controller to calibrate the printer to enable the recoater or a build material distributer to distribute a selected gradient of the build material onto the work area or an associated staging area.

10. The printer of claim 1, wherein the temperature sensor includes a first temperature sensor and a second temperature sensor.

11. A method, comprising:
monitoring a first temperature value at a first region of a work area of a printer and a second temperature value at a second region of the work area; and
in response to the first temperature value being a threshold different than the second temperature value, distributing a first amount of build material onto the first region and a second amount of the build material onto the second region.

12. An apparatus, comprising:
a temperature comparator to compare a first temperature value at a first region of a work area and a second temperature value at a second region of the work area; and
a build material distributing profile determiner to determine a build material distributing profile associated with distributing different amounts of build material on the first and second regions based on a difference between the first temperature and the second temperature.

13. The apparatus of claim 12, wherein the build material distributing profile is a first build material distributing profile, further including a build material consumption identifier to determine a second build material distributing profile based on the first region of the work area consuming different amounts of the build material compared to the second region.

14. The apparatus of claim 12, further including a build material profile controller to execute the build material distributing profile to cause a build material distributer to move at a first speed when distributing the build material on a staging area adjacent the first region and a second speed when distributing the build material on the staging area adjacent the second region

15. The apparatus of claim 12, further including a build material profile controller to execute the build material distributing profile to cause a recoater to move at a first speed when distributing the build material on the first region and a second speed when distributing the build material on the second region.
